(19) United States
(12) Patent Application Publication
(10) Pub. No.: US 2007/0013988 A1
(43) Pub. Date: Jan. 18, 2007

(54) Optical scanner, and image forming apparatus with the same

(75) Inventor: Masanori Okada, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/481,519

(22) Filed: Jul. 6, 2006

(30) Foreign Application Priority Data
Jul. 13, 2005 (JP) 2005-203756

(51) Int. Cl. G02B 26/08

(52) U.S. Cl. 359/212; 359/198

(57) ABSTRACT

When a mirror starts to operate, the voltage applied between a fixed-electrode side pad and a mirror-electrode side pad is lowered below a predetermined voltage, so that the electrostatic attraction which works between a fixed electrode and a mirror electrode becomes smaller. Thereby, the mirror's driving force becomes smaller, and at the mirror's start time, the mirror's vibration angle becomes narrower than a predetermined vibration angle. The applied voltage between the fixed-electrode side pad and the mirror-electrode side pad is linearly or stepwise increased according to the time which has elapsed since the mirror's start and the mirror is vibrated at the predetermined vibration angle by setting the voltage applied to the predetermined voltage when a predetermined time has elapsed since the mirror's start.

### BACKGROUND OF THE INVENTION

1. Field of the Invention

The present invention relates to an optical scanner which scans a light beam by vibrating a mirror. It also relates to an image forming apparatus, such as a printer, a facsimile and a copier, which includes this optical scanner.

2. Description of the Related Art

Conventionally, an optical scanner has been known which scans a light beam such as a laser beam. This optical scanner is provided in an image forming apparatus, such as a printer, a facsimile and a copier. In this optical scanner, a laser beam emitted from a semiconductor laser is incident upon a polygon mirror which rotates at high speed. The laser beam reflected by the polygon mirror is scanned on a photosensitive drum. Then, an electrostatic latent image is formed on the surface of this photosensitive drum.

On the other hand, in recent years, in order to enhance the resolution of an image, or in order to increase the print speed of an image, the polygon mirror has been designed to rotate faster. However, if the polygon mirror's rotational speed becomes higher, various problems may arise, such as a deterioration in the durability of a bearing which supports the polygon mirror's rotation shaft, the generation of heat in the polygon mirror which is caused by the friction (i.e., windage loss) of the polygon mirror's surface with air, and the noise or heat generation of a motor which rotates the polygon mirror.

In order to resolve these disadvantages, an optical scanner is proposed in which instead of the polygon mirror, a mirror is formed by a silicon substrate, and this mirror is vibrated using resonance (refer to Japanese Patent Laid-Open No. 11-52278 specification). In this optical scanner, a mirror formed by a silicon thin board is provided inside of a concave portion formed in a rectangular support substrate. From side surfaces of this mirror, two torsion bars protrude outward and are supported to the support substrate. Then, a mirror electrode portion is formed at least in the area around or surface of the mirror. Besides, on each upper surface on both sides of the concave portion formed in the support substrate, a fixed electrode is provided via an insulator. This fixed electrode is located above the mirror electrode portion.

Then, if a predetermined voltage is applied between either of the two fixed electrodes and the mirror electrode portion, an electrostatic attraction works between this fixed electrode and the mirror electrode portion. Thereby, the mirror rotates up to the position where the inertia force produced in the mirror is equal to the restoring force of each torsion bar. In terms of the two fixed electrodes, the fixed electrode given such a voltage alternates with the other, so that the mirror can be vibrated at a predetermined vibration angle.

In the above described optical scanner, in order to vibrate the mirror, the electrostatic attraction is used which works between the fixed electrode and the mirror electrode portion. However, a galvano-mirror which is vibrated by electro-magnetic force is also presented (refer to Japanese Patent Laid-Open No. 7-175005 specification). In this galvano-mirror, a movable plate in which a total-reflection mirror is formed is provided inside of a frame-shaped silicon substrate. From side surfaces of this movable plate, two torsion bars protrude outward and are supported to the silicon substrate. Then, a flat coil is provided in the part around the upper surface of the movable plate. Besides, in each mutually-opposite position on the silicon substrate's upper surface, a circular permanent magnet is provided via an upside glass substrate. On the other hand, in each mutually-opposite position on the silicon substrate's lower surface, a circular permanent magnet is provided via a downside glass substrate.

Between the permanent magnet placed on the upper-surface side of the silicon substrate and the permanent magnet placed on the lower-surface side of the silicon substrate, a magnetic field is formed in the directions across the flat coil. Therefore, if an electric current is sent to the flat coil, then according to the flat coil's current density and magnetic-flux density, electro-magnetic force is generated at both ends of the movable plate. Thereby, the total-reflection mirror rotates up to the position where the inertia force produced in the mirror is equal to the restoring force of each torsion bar. By alternately changing the direction in which an electric current flows through the flat coil, the total-reflection mirror can be vibrated at a predetermined vibration angle.

Herein, in the former optical scanner, the resonance frequency of the mirror is determined by the mirror's inertia moment and each torsion bar's spring constant. Then, the vibration angle of the mirror is calculated, based on the mirror's drive frequency, and the driving force given to the mirror by the electrostatic attraction which works between the fixed electrode and the mirror electrode portion. In order to vibrate the mirror at a predetermined vibration angle, a predetermined voltage needs to be applied between the fixed electrode and the mirror electrode portion, so that the driving force which corresponds to the mirror's resonance frequency can be given to the mirror.

However, when the mirror starts to operate, if a predetermined voltage is applied between the fixed electrode and the mirror electrode portion so that the mirror can be vibrated at the predetermined vibration angle, then the driving force given to the mirror by the electrostatic attraction which works between these fixed electrode and mirror electrode balances with the mirror's inertia moment. As a result, the mirror is kept at a stop, thus making it difficult to vibrate the mirror at the predetermined vibration angle. This disadvantage is also raised even in the latter optical scanner.

### SUMMARY OF THE INVENTION

It is an object of the present invention to provide an optical scanner which is capable of vibrating a mirror using resonance, certainly without any defect even when the mirror starts to operate, as well as an image forming apparatus which includes this optical scanner.

An optical scanner according to an aspect of the present invention, comprising: a light source which emits a light beam; a vibrating mirror which vibrates a mirror using resonance and allows the mirror to reflect a light beam emitted from the light source so that the light beam is scanned on a scanned surface; and a mirror drive circuit which applies a drive signal to the vibrating mirror and vibrates the mirror at a first vibration angle when the light beam is scanned on the scanned surface, wherein the mirror drive circuit vibrates the mirror at a second vibration angle narrower than the first vibration angle when the mirror starts to operate.

An image forming apparatus according to another aspect of the present invention, comprising: a photosensitive drum which forms an electrostatic latent image on its surface; and the above described optical scanner, wherein the light beam reflected by the mirror of the optical scanner is scanned on the photosensitive drum uniformly charged so that an electrostatic latent image is formed in the part scanned by the light beam on the surface of the photosensitive drum.

In this optical scanner or image forming apparatus, the mirror starts to vibrate at a vibration angle narrower than a predetermined vibration angle at the time when a light beam is scanned on a scanned surface. Therefore, in the optical scanner which vibrates the mirror using resonance, the mirror can be certainly prevented from malfunctioning at its start time.

These and other objects, features and advantages of the present invention will become more apparent upon reading of the following detailed description along with the accompanied drawings.

### BRIEF DESCRIPTION OF THE DRAWINGS

FIG. 1 is a schematic view of an image forming apparatus according to an embodiment of the present invention, showing its configuration.

FIG. 2 is a schematic view of a laser scanner in the image forming apparatus according to the embodiment of the present invention, showing its configuration.

FIGS. 3A and 3B are schematic views of a vibrating mirror in the laser scanner of the image forming apparatus according to the embodiment of the present invention, showing its configuration.

FIG. 4 is a graphical representation, showing the relation between the drive voltage of a mirror and the vibration angle of the mirror.

FIG. 5 is a graphical representation, showing the relation between the drive frequency of the mirror and the vibration angle of the mirror.

FIG. 6 is a graphical representation, showing the relation between the elapse of time after the mirror starts to operate and the mirror's drive voltage when the mirror's drive voltage is linearly changed.

FIG. 7 is a graphical representation, showing the relation between the elapse of time after the mirror starts to operate and the mirror's drive voltage when the mirror's drive voltage is stepwise changed.

FIG. 8 is a graphical representation, showing the relation between the elapse of time after the mirror starts to operate and the mirror's drive frequency when the mirror's drive frequency is linearly changed.

FIG. 9 is a graphical representation, showing the relation between the elapse of time after the mirror starts to operate and the mirror's drive frequency when the mirror's drive frequency is stepwise changed.

### DETAILED DESCRIPTION OF THE PREFERRED EMBODIMENTS

Hereinafter, an embodiment of the present invention will be described in detail with reference to the attached drawings.

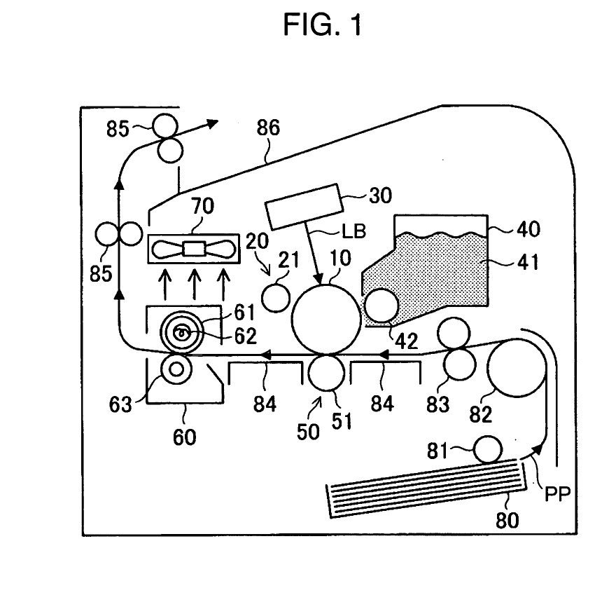

As shown in FIG. 1, an image forming apparatus according to the embodiment includes: a photosensitive drum 10; a charging unit 20 which charges the whole surface of this photosensitive drum 10; a laser scanner 30 which irradiates the photosensitive drum 10's surface with a laser beam LB; a development unit 40 which executes a development by allowing a toner 41 to adhere to an electrostatic latent image formed on the surface of the photosensitive drum 10; a transfer unit 50 which transfers, to sheet, the toner 41 which has adhered onto the surface of the photosensitive drum 10; a fixing unit 60 which fixes the toner 41 transferred to the sheet on the sheet; a cooling fan 70 which cools the inside of the image forming apparatus by radiating the heat generated in the fixing unit 60 from the image forming apparatus.

In addition, as shown in FIG. 1, this image forming apparatus includes: a sheet-feed cassette 80 which houses a plurality of sheets; a sheet-feed roller 81 which feeds the sheet from the sheet-feed cassette 80; a conveying roller 82 which conveys the sheet fed by the sheet-feed roller 81; a pair of registration rollers 83 which orients the sheet which has passed through the conveying roller 82 in the right direction and adjusts the timing in conveying the sheet; a conveying guide 84 for conveying the sheet from the pair of registration rollers 83 to the photosensitive drum 10 and conveying, to the fixing unit 60, the sheet which has passed through the photosensitive drum 10; a discharge roller 85 which discharges, from the image forming apparatus, the sheet which has passed through the fixing unit 60; and a discharge tray 86 which stores the sheet discharged to the outside of the image forming apparatus from the discharge roller 85.

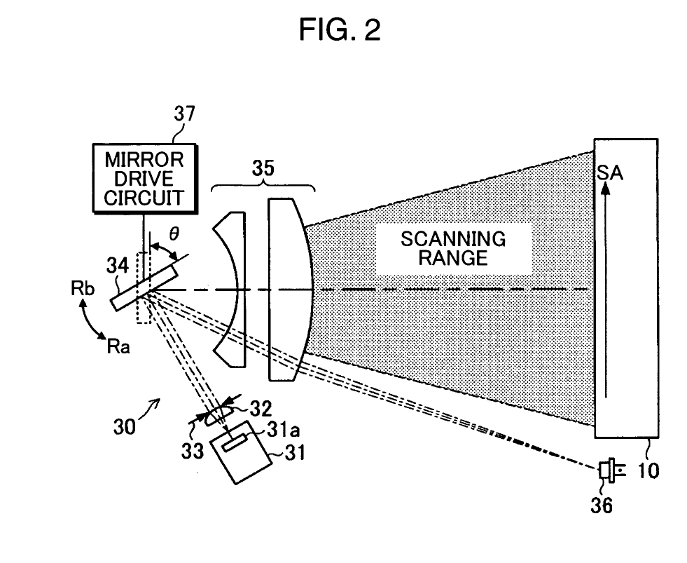

In the image forming apparatus which has such a configuration, the charging unit 20 is provided with a charging roller 21 shown in FIG. 1. This charging roller 21 is located near the photosensitive drum 10 and the charging roller 21 charged with electricity discharges so that the photosensitive drum 10's surface becomes negatively charged. Furthermore, as shown in FIG. 1, the laser scanner 30 irradiates the photosensitive drum 10 with the laser beam LB emitted from a semiconductor laser 31a (see FIG. 2). In the photosensitive drum 10, the electric potential of the part irradiated with the laser beam LB is dropped, so that an electrostatic latent image is formed in this part. The configuration of the laser scanner 30 will be described later in detail with reference to the drawings.

Furthermore, as shown in FIG. 1, the development unit 40 is located near the photosensitive drum 10. Inside of it, the toner 41 is stored, and it includes a development roller 42 which supplies the toner 41 to the photosensitive drum 10. The development unit 40 executes a development by allowing the toner 41 to adhere to the electrostatic latent image formed on the surface of the photosensitive drum 10. Then, the transfer unit 50 includes a transfer roller 51 shown in FIG. 1. Between this transfer roller 51 and the photosensitive drum 10, there is formed a nip portion which nips the sheet. When the sheet passes through this nip portion, the transfer unit 50 pulls the toner 41 which has adhered to the photosensitive drum 10 toward the transfer roller 51 positively charged. Thereby, this toner 41 is transferred to the sheet.

Moreover, as shown in FIG. 1, the fixing unit 60 includes a fixing roller 61, a fixing heater 62 which is provided inside of this fixing roller 61 and heats the fixing roller 61, and a pressure roller 63. Between this fixing roller 61 and the pressure roller 63, there is formed a nip portion which nips the sheet. When the sheet passes through this nip portion, the fixing unit 60 melts the toner 41 transferred to the sheet, using the heat of the fixing roller 61. Simultaneously, using the pressure roller 63, it applies pressure to the sheet, so that the toner 41 is fixed onto the sheet.

In addition, in the image forming apparatus configured in this way, as shown in FIG. 2, the laser scanner 30 includes: a laser unit 31 provided with the semiconductor laser 31a as the light source which emits a laser beam; a collimating lens 32 which transforms the laser beam emitted by the semiconductor laser 31a into a parallel luminous flux; a diaphragm 33 which adjusts the quantity and diameter of the laser beam which has passed through the collimating lens 32; a vibrating mirror 34 which vibrates a mirror using resonance, at a predetermined vibration angle in the directions shown by arrows Ra, Rb of FIG. 2, so that the reflected angle of the laser beam can be continuously changed; an f-θ lens 35 which corrects the scanning speed of the laser beam reflected by the vibrating mirror 34; a beam-detection sensor 36 (hereinafter, referred to as the “BD sensor 36”) which detects the laser beam transmitted in the f-θ lens 35 after reflected by the vibrating mirror 34; and a mirror drive circuit 37 which applies a drive signal to the vibrating mirror 34, and thereby, vibrates the vibrating mirror 34 at a vibration angle which corresponds to the amplitude of the applied voltage of the drive signal, or at a vibration angle which corresponds to the drive frequency set according to the drive signal.

In the laser scanner 30 configured in this way, if the vibrating mirror 34 is given a predetermined drive voltage by the mirror drive circuit 37, it vibrates at a predetermined vibration angle. Then, as the vibrating mirror 34 moves in the direction of the arrow Ra shown in FIG. 2, in other words, as the vibrating mirror 34 moves from its position shown by a solid line to the position shown by a dashed line in FIG. 2, the laser beam reflected by the vibrating mirror 34 is transmitted in the f-E lens 35. Then, the laser beam is scanned on the surface of the photosensitive drum 10 in the direction of an arrow Sa shown in FIG. 2. At this time, in the photosensitive drum 10's surface, an electrostatic latent image is formed in the part irradiated with the laser beam. Then, image data is written to the photosensitive drum 10.

The BD sensor 36 is used for adjusting the timing in writing the image data to the photosensitive drum 10. When the vibrating mirror 34 moves in the direction of the arrow Rb shown in FIG. 2 and comes to the position shown by the solid line, the laser beam reflected by the vibrating mirror 34 is transmitted in the f-θ lens 35. Then, it is incident upon the BD sensor 36. Hence, if the vibrating mirror 34 vibrates at the predetermined vibration angle, the laser beam is incident on the BD sensor 36 in predetermined timing. In the BD sensor 36, a detection signal is detected in the predetermined timing. Then, using the detection signal of the BD sensor 36, the vibrating mirror 34's vibration angle is changed, so that the timing in which the image data is written to the photosensitive drum 10 can be adjusted.

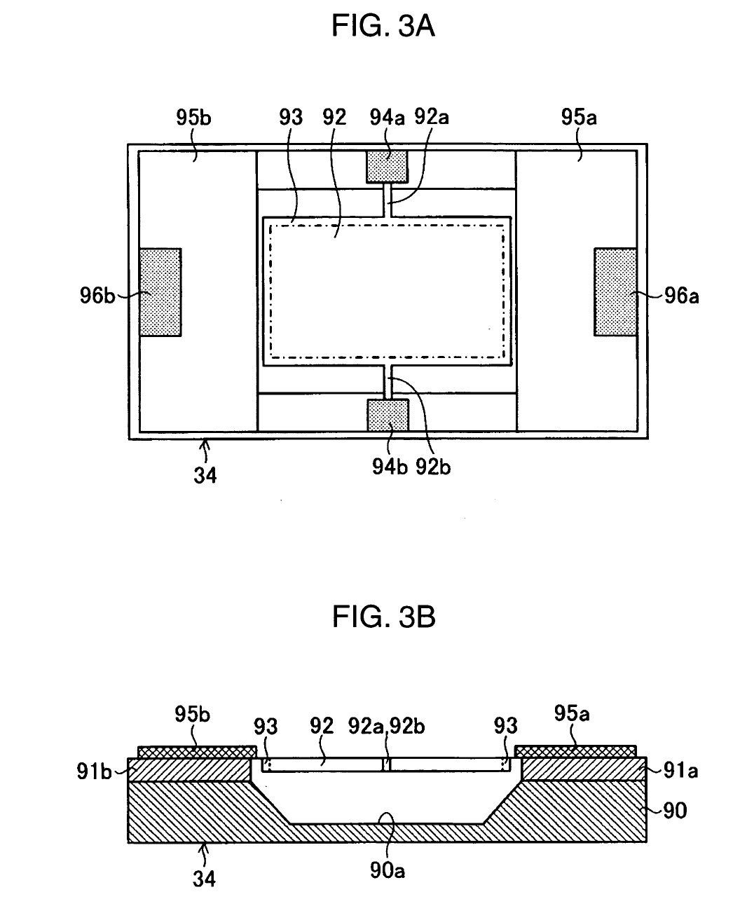

FIG. 3A is a plan view of the vibrating mirror 34 installed in the laser scanner 30, and FIG. 3B is a sectional view of the vibrating mirror 34 installed in the laser scanner 30.

As shown in FIG. 3A and FIG. 3B, in the vibrating mirror 34, a concave portion 90a is formed in the middle part of a support substrate 90 formed by a rectangular thick board. On both sides of the support substrate 90, rectangular insulators 91a, 91b are provided on its upper surface so that they cross the concave portion 90a. In the concave portion 90a of the support substrate 90, a mirror 92 formed by a silicon thin board is provided which is parallel to the bottom surface of the concave portion 90a. In the mirror 92, its upper surface is located substantially as high as the upper surfaces of the insulators 91a, 91b.

In the mirror 92, two torsion bars 92a, 92b which protrude outward from sideways are united with the mirror 92's body. In the mirror 92, the end part of each torsion bar 92a, 92b is supported via each insulator 91a, 91b to the support substrate 90. Thereby, the mirror 92 is supposed to be vibrated in the directions perpendicular to the mirror 92's plane directions by the torsion of each torsion bar 92a, 92b. Then, a conductive mirror electrode 93 is formed at least in the area around or surface of the mirror 92. Besides, the two torsion bars 92a, 92b formed in the mirror 92 are connected, at their end parts, to mirror-electrode side pads 94a, 94b which are provided on the upper surfaces of the insulators 91a, 91b, respectively.

In addition, a conductive rectangular fixed electrode 95a, 95b is provided on the upper surface of each insulator 91a, 91b located on the support substrate 90, respectively. In other words, in these fixed electrodes 95a, 95b, their lower-surface height is almost equal to that of the mirror 92's upper surface. In these fixed electrodes 95a, 95b, their inner-edge parts are located inward from the inner-edge parts of the insulators 91a, 91b, respectively, so that they cover a part of the concave portion 90a formed in the support substrate 90. Hence, they are adjacent to the mirror electrode 93 formed in the peripheral area of the mirror 92. In addition, a fixed-electrode side pad 96a, 96b is provided on the upper surface of each fixed electrode 95a, 95b, respectively. Incidentally, the configuration of a vibrating mirror used in the laser scanner 30 is not limited especially to the above described example. Various vibrating mirrors can be used, as long as they vibrate a mirror using resonance. For example, a vibrating mirror may also be used which vibrates a mirror using electro-magnetic force by a permanent magnet and a coil.

In the image forming apparatus configured in this way, if the power source of the image forming apparatus is turned on, the power is supplied to each unit inside of the image forming apparatus. At the same time, the operation is controlled of each unit inside of the image forming apparatus. Thereby, in the image forming apparatus shown in FIG. 1, each process of the above described charging process, exposure process, development process, transfer process and fixation processes is executed in order.

Specifically, in the image forming apparatus, as shown by a solid-line arrow PP in FIG. 1, the sheet is fed from the sheet-feed cassette 80 by the sheet-feed roller 81. Then, the sheet fed from the sheet-feed cassette 80 is conveyed to the conveying roller 82. Next, in the pair of registration rollers 83, the sheet which has passed through the conveying roller 82 is oriented in the right direction. Then, the timing in conveying it to the photosensitive drum 10 is also adjusted. Thereafter, along the conveying guide 84, the sheet is conveyed to the nip portion between the photosensitive drum 10 and the transfer roller 51.

When the sheet is conveyed toward the photosensitive drum 10 in this way, first, in the charging process, the charging unit 20 charges the entire surface of the photosensitive drum 10, using the charging roller 21's discharging electricity. Simultaneously, in the exposure process, the laser scanner 30 irradiates the photosensitive drum 10 with the laser beam from the semiconductor laser 31a shown in FIG. 2. In the photosensitive drum 10's surface, an electrostatic latent image is formed in the part irradiated with the laser beam.

Specifically, as shown in FIG. 2, the laser beam emitted by the semiconductor laser 31a of the laser unit 31 is changed into a parallel luminous flux by the collimating lens 32. Then, the quantity and diameter of the laser beam is adjusted by the diaphragm 33, and thereafter, it is incident on the vibrating mirror 34. Then, if the vibrating mirror 34 moves in the direction of the arrow Ra shown in FIG. 2, in other words, if the vibrating mirror 34 moves from the position shown by the solid line to the position shown by the dashed line in FIG. 2, then the laser beam which has been transmitted in the f-θ lens 35 after reflected by the vibrating mirror 34 scans on the photosensitive drum 10. Thereby, at this time, image data is written to the photosensitive drum 10.

Next, in the development process, using the development roller 42, the development unit 40 supplies the charged toner 41 to the photosensitive drum 10. Thereby, it executes a development by allowing this toner 41 to adhere to the electrostatic latent image formed on the surface of the photosensitive drum 10. Sequentially, in the transfer process, the transfer unit 50 transfers the toner 41 which has adhered to the surface of the photosensitive drum 10 to the sheet which passes through the nip portion between the photosensitive drum 10 and the transfer roller 51. Then, the sheet which has the toner 41 transferred in the transfer process passes through the conveying guide 84. Then, it is conveyed to the nip portion between the fixing roller 61 and the pressure roller 63 in the fixing unit 60.

When the power source of the image forming apparatus is turned on, the power begins to be supplied to the fixing heater 62, so that the fixing heater 62 is heated. This fixing heater 62 heats the fixing roller 61 up to the temperature at which the toner 41 can be stably fixed on the sheet. Then, in the fixation process, using the heat of the fixing roller 61, the fixing unit 60 melts the toner 41 on the sheet which passes through the nip portion between the fixing roller 61 and the pressure roller 63 in the fixing unit 60. Simultaneously, using the pressure roller 63, it applies pressure to the sheet, so that the toner 41 is fixed on the sheet. The sheet which has the toner 41 fixed in the fixation process is conveyed to the outside of the image forming apparatus by the discharge roller 85. Finally, it is discharged to the discharge tray 86.

In the image forming apparatus which executes an operation like this, as described above, the vibrating mirror 34 shown in FIG. 2 is given a predetermined drive voltage by the mirror drive circuit 37. Thereby, it vibrates at a predetermined vibration angle. This operation of the vibrating mirror 34 will be described in detail with reference to FIG. 3A and FIG. 3B.

As shown in FIG. 3A, if a predetermined voltage is applied between the fixed-electrode side pad 96a placed on the fixed electrode 95a which is one of the fixed electrodes 95a, 95b formed on the upper surface of each insulator 91a, 91b, and the mirror-electrode side pads 94a, 94b connected to each torsion bar 92a, 92b, then the voltage is applied from the mirror-electrode side pads 94a, 94b via each torsion bar 92a, 92b to the mirror electrode 93. Thereby, on the fixed electrode 95a's surface and the mirror electrode 93's surface, an electric charge is stored which has an opposite polarity to each other. Consequently, a capacitor is formed between the fixed electrode 95a and the mirror electrode 93. Then, an electrostatic attraction works between the fixed electrode 95a (i.e., the part opposite to the mirror electrode 93 in the fixed electrode 95a) and the mirror electrode 93 (i.e., the part opposite to the fixed electrode 95a in the mirror electrode 93).

Herein, as described earlier, the fixed electrode 95a is located above the mirror electrode 93. Hence, the electrostatic attraction exerted between the fixed electrode 95a and the mirror electrode 93 causes each torsion bar 92a, 92b of the mirror 92 to be distorted at the same angle. Thereby, the mirror 92 begins to turn counterclockwise, so that the fixed electrode 95a and the mirror electrode 93 come closer to each other. When the distance between the fixed electrode 95a and the mirror electrode 93 reaches the minimum, the voltage application between the fixed-electrode side pad 96a and each mirror-electrode side pad 94a, 94b comes to a halt. At this time, in the mirror 92, an inertia force is produced by its turning operation. Thus, the mirror 92 turns so that its mirror electrode 93 goes beyond the position of the fixed electrode 95a.

If the inertia force given to the mirror 92 becomes equal to the restoring force of each torsion bar 92a, 92b, then the mirror 92 stops turning. Then, the mirror 92 begins to turn clockwise, so that the fixed electrode 95a and the mirror electrode 93 come closer to each other.

Sequentially, the fixed electrode 95a and the mirror electrode 93 come close to each other, up to the position in which an electrostatic attraction works between the fixed electrode 95a and the mirror electrode 93. At this time, if the voltage starts to be applied between the fixed-electrode side pad 96a and each mirror-electrode side pad 94a, 94b, then the electrostatic attraction exerted between the fixed electrode 95a and the mirror electrode 93 accelerates the mirror 92's rotation. When the distance between the fixed electrode 95a and the mirror electrode 93 comes to the minimum, the voltage application between the fixed-electrode side pad 96a and each mirror-electrode side pad 94a, 94b is brought to a halt. Thereafter, the mirror 92 returns to the position shown in FIG. 3B.

After the mirror 92 has returned to the position shown in FIG. 3B, as shown in FIG. 3A, if a predetermined voltage is applied between the fixed-electrode side pad 96b placed on the fixed electrode 95b which is the other of the fixed electrodes 95a, 95b formed on the upper surface of each insulator 91a, 91b, and the mirror-electrode side pads 94a, 94b connected to each torsion bar 92a, 92b, then the voltage is applied from the mirror-electrode side pads 94a, 94b via each torsion bar 92a, 92b to the mirror electrode 93. Thereby, on the fixed electrode 95b's surface and the mirror electrode 93's surface, an electric charge is stored which has an opposite polarity to each other. Consequently, a capacitor is formed between the fixed electrode 95b and the mirror electrode 93.

Then, the electrostatic attraction which works between the fixed electrode 95b (i.e., the part opposite to the mirror electrode 93 in the fixed electrode 95b) and the mirror electrode 93 (i.e., the part opposite to the fixed electrode 95b in the mirror electrode 93) causes each torsion bar 92a, 92b of the mirror 92 to be distorted at the same angle. Thereby, the mirror 92 begins to turn clockwise, so that the fixed electrode 95b and the mirror electrode 93 come closer to each other. Thereafter, when the distance between the fixed electrode 95b and the mirror electrode 93 reaches the minimum, the voltage application between the fixed-electrode side pad 96b and each mirror-electrode side pad 94a, 94b comes to a halt. At this time, in the mirror 92, an inertia force is produced by its turning operation. Thus, the mirror 92 turns so that its mirror electrode 93 goes beyond the position of the fixed electrode 95b.

If the inertia force given to the mirror 92 becomes equal to the restoring force of each torsion bar 92a, 92b, then the mirror 92 stops turning. Then, the mirror 92 begins to turn counterclockwise, so that the fixed electrode 95b and the mirror electrode 93 come closer to each other.

Sequentially, the fixed electrode 95b and the mirror electrode 93 come close to each other, up to the position in which an electrostatic attraction works between the fixed electrode 95b and the mirror electrode 93. At this time, if the voltage starts to be applied between the fixed-electrode side pad 96b and each mirror-electrode side pad 94a, 94b, then the electrostatic attraction exerted between the fixed electrode 95b and the mirror electrode 93 accelerates the mirror 92's rotation. When the distance between the fixed electrode 95b and the mirror electrode 93 comes to the minimum, the voltage application between the fixed-electrode side pad 96b and each mirror-electrode side pad 94a, 94b is brought to a halt. Thereafter, the mirror 92 returns to the position shown in FIG. 3B.

In this way, a predetermined voltage is alternately applied between the mirror-electrode side pads 94a, 94b and the fixed-electrode side pad 96a and between the mirror-electrode side pads 94a, 94b and the fixed-electrode side pad 96b. Thereby, an electrostatic attraction is given between the fixed electrodes 95a, 95b and the mirror electrode 93. This electrostatic attraction exerted between the fixed electrodes 95a, 95b and the mirror electrode 93 gives a driving force to the mirror 92. This driving force allows the mirror 92 to vibrate at a predetermined vibration angle.

When the mirror 92 makes such a motion, a resonance frequency f₀ of the mirror 92 is calculated, based on an inertia moment J of the mirror 92 and a spring constant k of each torsion bar 92a, 92b, in the following expression (1).
f₀=(½π)×(k/J)^{1/2} (1)

In this way, the mirror 92's resonance frequency f₀ is determined by the configuration of each torsion bar 92a, 92b and the configuration of the mirror 92. In addition, based on a driving force M given to the mirror 92 by the electrostatic attraction which works between the fixed electrodes 95a, 95b and the mirror electrode 93 and the spring constant k of each torsion bar 92a, 92b as shown in FIG. 3A, a predetermined vibration angle θ₀ of the mirror 92 is calculated in the following expression (2).
θ₀=M/k (2)

Using these expression (1) and expression (2), the predetermined vibration angle θ₀ of the mirror 92 is calculated in the following expression (3).
θ₀=(¼π²)×(M/f₀²J) (3)

In this way, the mirror 92's predetermined vibration angle θ₀ is determined by the driving force M given to the mirror 92 by the electrostatic attraction which works between the fixed electrodes 95a, 95b and the mirror electrode 93 when a predetermined voltage is applied between the mirror-electrode side pads 94a, 94b and the fixed-electrode side pads 96a, 96b. In short, it is determined in accordance with the amplitude of such an applied voltage.

Using the above described expression (3), if the mirror 92's drive frequency is f, then a vibration angle θ of the mirror 92 is calculated in the following expression (4).
θ=(¼π²)×(M/f²J) (4)

As can be seen from this expression (4), the higher the mirror 92's drive frequency f becomes, or the weaker the mirror 92's drive force M becomes, the narrower the mirror 92's vibration angle θ will be. In contrast, the expression (4) also suggests that the lower the mirror 92's drive frequency f becomes, or the greater the mirror 92's drive force M becomes, the wider the mirror 92's vibration angle θ will be.

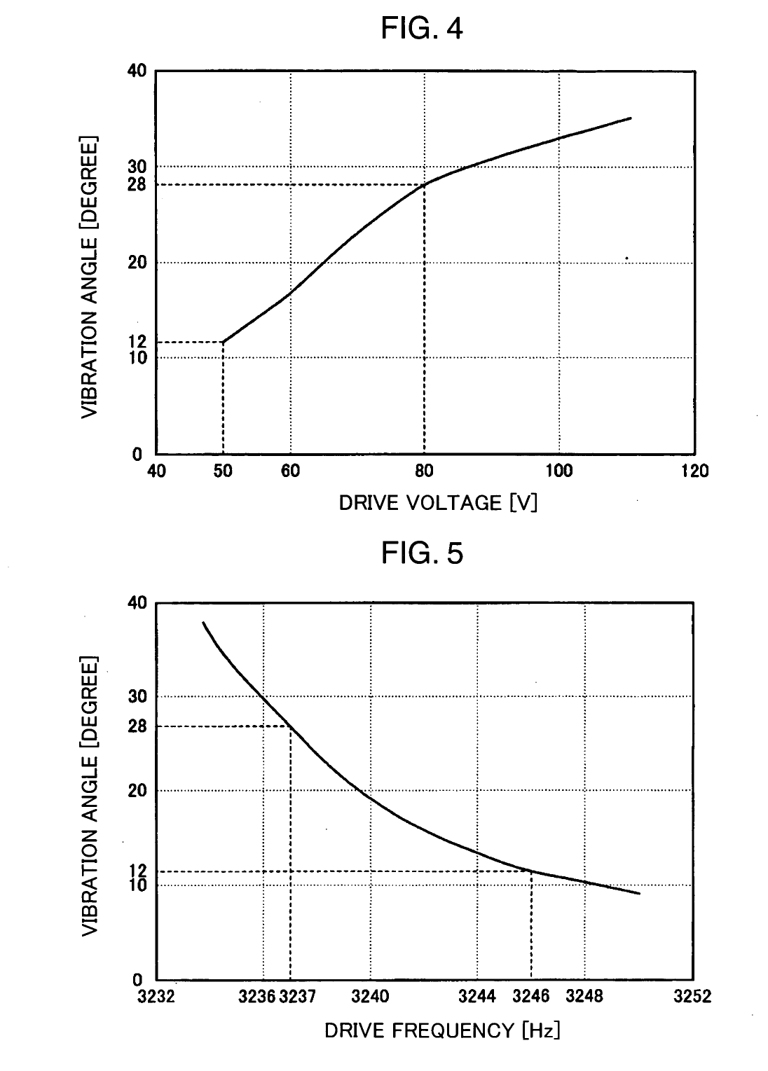

Specifically, as shown in FIG. 4, the horizontal axis indicates the voltage (i.e., the mirror 92's drive voltage) which is applied between the fixed-electrode side pads 96a, 96b and the mirror-electrode side pads 94a, 94b. On the other hand, the vertical axis indicates the mirror 92's vibration angle. In this graph, as the mirror 92's drive voltage becomes higher, the mirror 92's vibration angle is widened. For example, if the mirror 92 is driven at a drive voltage of 50 [V], the mirror 92's vibration angle becomes approximately 12 [degree] If the mirror 92 is driven at a drive voltage of 80 [V], the mirror 92's vibration angle becomes approximately 28 [degree].

In addition, as shown in FIG. 5, the horizontal axis indicates the mirror 92's drive frequency, and the vertical axis indicates the mirror 92's vibration angle. In this graph, as the mirror 92's drive frequency becomes higher, the mirror 92's vibration angle is narrowed. For example, if the mirror 92 is driven at a drive frequency of 3246 [Hz], the mirror 92's vibration angle becomes approximately 12 [degree]. If the mirror 92 is driven at a drive frequency of 3237 [Hz], the mirror 92's vibration angle becomes approximately 28 [degree].

As can be seen from the above described expression (3), in order to vibrate the mirror 92 at the predetermined vibration angle θ₀, the drive force M which corresponds to the mirror 92's resonance frequency f₀ calculated in the above described expression (1) needs to be given to this mirror 92.

However, when the mirror 92 starts to operate, if a predetermined voltage is applied between the fixed electrodes 95a, 95b and the mirror electrode 93 so that the mirror 92 can be vibrated at the predetermined vibration angle θ₀, then the driving force M given to the mirror 92 by the electrostatic attraction which works between these fixed electrodes 95a, 95b and mirror electrode 93 balances with the mirror 92's inertia moment J. This makes it difficult to vibrate the mirror 92 at the predetermined vibration angle θ₀.

In contrast, in this image forming apparatus, when the mirror 92 starts to be operated, the mirror 92's driving force M and the mirror 92's inertia moment J are unbalanced. This allows the mirror 92 to begin vibrating at a vibration angle θ narrower than the predetermined vibration angle θ₀. Then, as time passes after the mirror 92 is started, the mirror 92's vibration angle θ is stepwise increased. When a laser beam scans on the photosensitive drum 10 after an image formation operation begins, the mirror 92 is vibrated at the predetermined vibration angle θ₀.

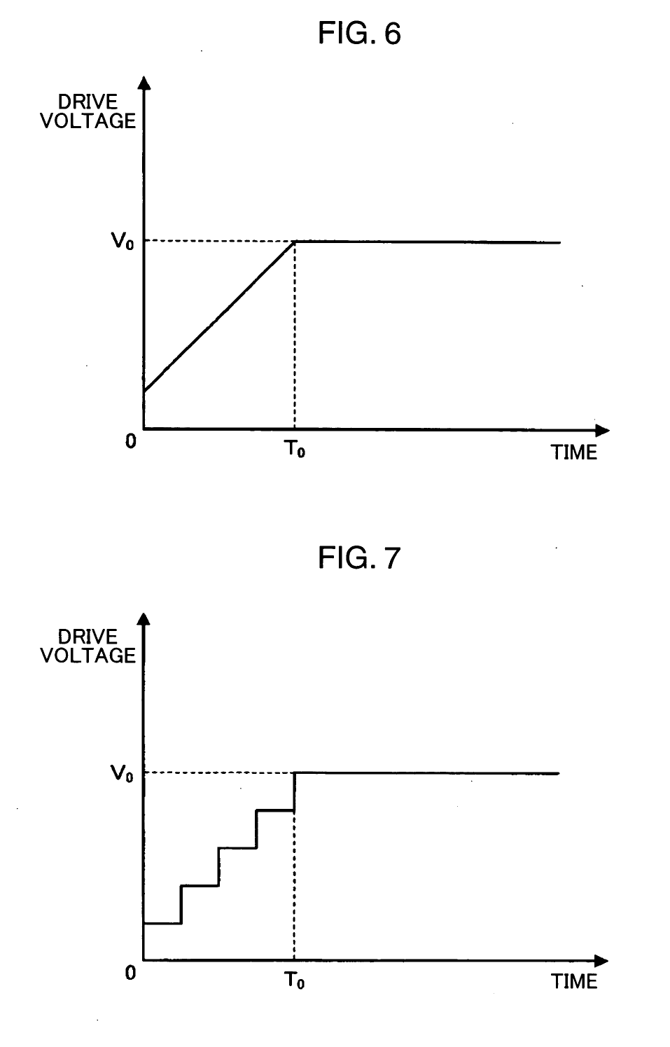

As this method, first, at the mirror 92's start time, as shown in FIG. 6 and FIG. 7, the mirror drive circuit 37 lowers the voltage value which is applied between the fixed-electrode side pads 96a, 96b and the mirror-electrode side pads 94a, 94b, below a predetermined voltage value V₀ (i.e., the voltage value at the time when the mirror 92 vibrates at the predetermined vibration angle θ₀). This weakens the electrostatic attraction which works between the fixed electrodes 95a, 95b and the mirror electrode 93. Thereby, the mirror 92's driving force M becomes smaller, and thus, at the mirror 92's start time, the mirror 92's vibration angle θ becomes smaller than the predetermined vibration angle θ₀.

Then, as shown in FIG. 6, when a time T₀ has elapsed since the mirror 92 started to operate, the applied voltage between the fixed-electrode side pads 96a, 96b and the mirror-electrode side pads 94a, 94b is set to the predetermined voltage value V₀. Then, the mirror drive circuit 37 raises the applied voltage linearly in accordance with the time which passes after the mirror 92's start, so that the mirror 92 is vibrated at the predetermined vibration angle θ₀. This can be realized in the form of hardware, if the image forming apparatus is provided with a circuit for increasing the applied voltage linearly in accordance with the time which passes after the mirror 92's start.

Incidentally, the method of raising such an applied voltage is not limited especially to the above described example. For example, the applied voltage may also be increased, like an exponential function, or gradually raising its increment per unit time, according to the time which has elapsed since the mirror 92 began to be operated. In this case, the mirror 92 can be certainly prevented from malfunctioning at its start time, and simultaneously, the start time T₀ which is taken to reach the predetermined vibration angle θ₀ can be shortened.

Furthermore, as shown in FIG. 7, when the time T₀ has elapsed since the mirror 92 started to operate, the applied voltage between the fixed-electrode side pads 96a, 96b and the mirror-electrode side pads 94a, 94b is set to the predetermined voltage value V₀. Then, the mirror drive circuit 37 increases the applied voltage stepwise (or in a staircase pattern) in accordance with the time which passes after the mirror 92's start, so that the mirror 92 is vibrated at the predetermined vibration angle θ₀. This can be realized in the form of software, by storing a program for setting the applied voltage at several steps in accordance with the time which passes after the mirror 92's start in a memory of the image forming apparatus, and executing this program in a CPU.

Incidentally, the method of raising such an applied voltage is not limited especially to the above described example. For example, the applied voltage may also be increased stepwise by raising, one by one, the applied voltage's increment at each step. In this case, the mirror 92 can be certainly prevented from malfunctioning at its start time, and simultaneously, the start time T₀ which is taken to reach the predetermined vibration angle θ₀ can be shortened.

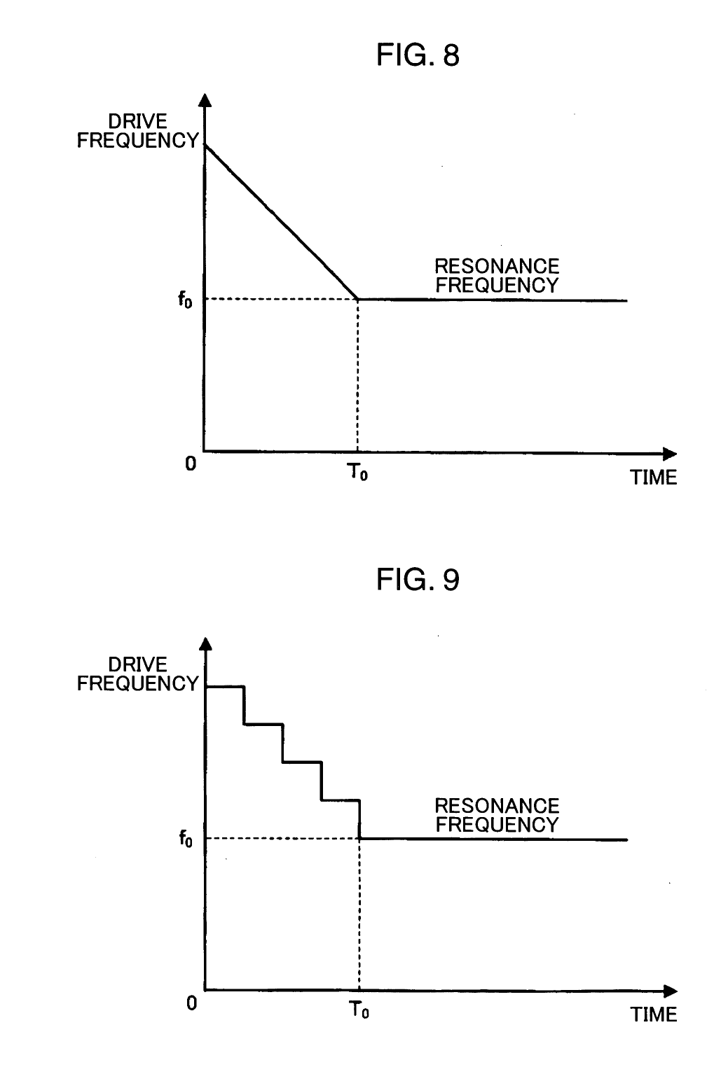

Moreover, as the method of widening the mirror 92's vibration angle θ stepwise in accordance with the time which elapses from the mirror 92's start, other than the above described one, the following method is also mentioned. At the mirror 92's start time, as shown in FIG. 8 and FIG. 9, the mirror 92's drive frequency f is set to be higher than the mirror 92's resonance frequency f₀. Herein, using the above described expression (3) and expression (4), the following expression (5) can be obtained.
θ₀/θ=f²/f₀² (5)

As can be seen from this expression (5), if the mirror 92's drive frequency f is set above its resonance frequency f₀ at the mirror 92's start time, the mirror 92's vibration angle θ becomes narrower than the predetermined vibration angle θ₀. Hence, when the mirror 92 started to be operated, the mirror drive circuit 37 sets the mirror 92's drive frequency f to be higher than the resonance frequency f₀.

Then, as shown in FIG. 8, when the time T₀ has elapsed since the mirror 92 started, the mirror 92's drive frequency f is set to the resonance frequency f₀. Then, the mirror drive circuit 37 lowers the mirror 92's drive frequency f linearly in accordance with the time which passes after the mirror 92's start, so that the mirror 92 is vibrated at the predetermined vibration angle θ₀. This can be realized in the form of hardware, if the image forming apparatus is provided with a circuit for lowering the mirror 92's drive frequency f linearly in accordance with the time which passes after the mirror 92's start.

Incidentally, the method of lowering such a drive frequency is not limited especially to the above described example. For example, the drive frequency may also be lowered, like an exponential function, or gradually raising its decrement per unit time, according to the time which has elapsed since the mirror 92 began to be operated. In this case, the mirror 92 can be certainly prevented from malfunctioning at its start time, and simultaneously, the start time T₀ which is taken to reach the predetermined vibration angle θ₀ can be shortened.

In addition, as shown in FIG. 9, when the time T₀ has elapsed since the mirror 92 started, the mirror 92's drive frequency f is set to the resonance frequency f₀. Then, the mirror drive circuit 37 lowers the mirror 92's drive frequency f stepwise (or in a staircase pattern) in accordance with the time which passes after the mirror 92's start, so that the mirror 92 is vibrated at the predetermined vibration angle θ₀. This can be realized in the form of software, by storing a program for setting the mirror 92's drive frequency f at several steps in accordance with the time which passes after the mirror 92's start in a memory of the image forming apparatus, and executing this program in a CPU.

Incidentally, the method of lowering such a drive frequency is not limited especially to the above described example. For example, the drive frequency may also be lowered stepwise by increasing, one by one, the drive frequency's decrement at each step. In this case, the mirror 92 can be certainly prevented from malfunctioning at its start time, and simultaneously, the start time T₀ which is taken to reach the predetermined vibration angle θ₀ can be shortened.

In this embodiment, when the mirror 92 starts to be operated, the mirror drive circuit 37 applies, to the vibrating mirror 34, a voltage which is lower than the voltage at which the mirror 92 vibrates at the predetermined vibration angle θ₀. Thereby, the driving force M given to the mirror 92 becomes smaller, so that the balance of the mirror 92's driving force M and the mirror 92's inertia moment J can be lost. This prompts the mirror 92 to begin vibrating at a vibration angle narrower than the predetermined vibration angle θ₀.

Furthermore, in this embodiment, at the mirror 92's start time, the mirror drive circuit 37 sets, to the vibrating mirror 34, the drive frequency f which is higher than the one at which a light beam is scanned on the photosensitive drum 10 after the mirror 92's start. Thereby, the mirror 92's vibration angle at its start time can be kept from coinciding with the predetermined vibration angle θ₀ at which a light beam is scanned on the photosensitive drum 10 after the mirror 92's start. This puts the mirror 92's driving force M and the mirror 92's inertia moment J out of balance, thus allowing the mirror 92 to start vibrating at a vibration angle narrower than the predetermined vibration angle θ₀. Accordingly, in this embodiment, in the laser scanner 30 which vibrates the mirror 92 using resonance, the mirror 92 can be certainly prevented from malfunctioning at its start time.

As described so far, the present invention is useful for an optical scanner which vibrates a mirror and scans a light beam, an image forming apparatus such as a printer, a facsimile and a copier, a bar-code reader, an infrared camera and the like, which includes this optical scanner.

As described earlier, an optical scanner according to an aspect of the present invention, comprising: a light source which emits a light beam; a vibrating mirror which vibrates a mirror using resonance and allows the mirror to reflect a light beam emitted from the light source so that the light beam is scanned on a scanned surface; and a mirror drive circuit which applies a drive signal to the vibrating mirror and vibrates the mirror at a first vibration angle when the light beam is scanned on the scanned surface, wherein the mirror drive circuit vibrates the mirror at a second vibration angle narrower than the first vibration angle when the mirror starts to operate.

In this optical scanner, the vibrating mirror starts to vibrate at a vibration angle narrower than a predetermined vibration angle at the time when a light beam is scanned on a scanned surface. Therefore, in the optical scanner which vibrates the mirror using resonance, the mirror can be certainly prevented from malfunctioning at its start time.

It is preferable that the mirror drive circuit: apply a voltage to the vibrating mirror and vibrate the mirror at a vibration angle which corresponds to the amplitude of the applied voltage; when the light beam is scanned on the scanned surface, apply a first voltage to the vibrating mirror and vibrate the mirror at the first vibration angle; and when the mirror starts to operate, apply a second voltage lower than the first voltage to the vibrating mirror and vibrate the mirror at the second vibration angle.

In this case, when the mirror starts to operate, the voltage applied to the mirror is set to be lower than the one at which the light beam is scanned on the scanned surface after the mirror's start. Therefore, at the mirror's start time, the electrostatic attraction which is given to the mirror by applying the voltage to the vibrating mirror becomes smaller than that at the time when the light beam is scanned on the scanned surface after the mirror's start. Thereby, at the mirror's start time, the mirror's driving force and the mirror's inertia moment are unbalanced. This makes it possible to start vibrating the mirror at a vibration angle narrower than a predetermined vibration angle.

Preferably, the mirror drive circuit should linearly increase the voltage applied to the vibrating mirror so that the voltage applied to the vibrating mirror becomes the first voltage after a predetermined time elapses from the time when the mirror starts to operate.

In this case, until a predetermined time elapses from the time when the mirror starts to operate, the voltage applied to the vibrating mirror by the mirror drive circuit becomes linearly higher. Then, when the predetermined time has passed since the mirror's start, the voltage at which the mirror vibrates at a predetermined vibration angle is given to the vibrating mirror by the mirror drive circuit. In this way, the voltage applied to the vibrating mirror is linearly raised. This makes it possible to shift the mirror's vibration angle stably from the second vibration angle to the first vibration angle, as well as simplify the hardware configuration of the mirror drive circuit.

It is preferable that the mirror drive circuit stepwise increase the voltage applied to the vibrating mirror so that the voltage applied to the vibrating mirror becomes the first voltage after a predetermined time elapses from the time when the mirror starts to operate.

In this case, until a predetermined time elapses from the time when the mirror starts to operate, the voltage applied to the vibrating mirror by the mirror drive circuit becomes stepwise higher. Then, when the predetermined time has passed since the mirror's start, the voltage at which the mirror vibrates at a predetermined vibration angle is given to the vibrating mirror by the mirror drive circuit. In this way, the voltage applied to the vibrating mirror is raised stepwise one by one. Therefore, the mirror's vibration angle can be stably shifted from the second vibration angle to the first vibration angle. Simultaneously, this can be realized in the form of software, if the mirror drive circuit is made up of a CPU, a memory and the like and if a program for setting the voltage applied to the vibrating mirror at several steps according to the time which has elapsed since the mirror's start is stored in the memory and is executed by the CPU.

The mirror drive circuit may also: set a drive frequency of the mirror for the vibrating mirror and vibrate the mirror at a vibration angle which corresponds to the drive frequency; when the light beam is scanned on the scanned surface, set the drive frequency of the mirror to a first drive frequency and vibrate the mirror at the first vibration angle; and when the mirror starts to operate, sets a second drive frequency higher than the first drive frequency for the vibrating mirror and vibrate the mirror at the second vibration angle.

In this case, when the mirror starts to operate, the mirror's drive frequency is set to be higher than the one at which the light beam is scanned on the scanned surface after the mirror's start. In other words, the mirror's drive frequency at its start time is set to be higher than the mirror's resonance frequency. Thereby, the mirror's vibration angle at its start time can be prevented from coinciding with the predetermined vibration angle at which the light beam is scanned on the scanned surface after the mirror's start. This puts the mirror's driving force and the mirror's inertia moment out of balance, thus allowing the mirror to start vibrating at a vibration angle narrower than the predetermined vibration angle.

Preferably, the mirror drive circuit should linearly lower the drive frequency of the mirror so that the drive frequency of the mirror becomes the first drive frequency after a predetermined time elapses from the time when the mirror starts to operate.

In this case, until a predetermined time elapses from the time when the mirror starts to operate, the drive frequency of the mirror by the mirror drive circuit becomes linearly lower. Then, when the predetermined time has passed since the mirror's start, the drive frequency at which the mirror vibrates at a predetermined vibration angle is set for the vibrating mirror by the mirror drive circuit. In this way, the mirror's drive frequency is linearly lowered. This makes it possible to shift the mirror's vibration angle stably from the second vibration angle to the first vibration angle, as well as simplify the hardware configuration of the mirror drive circuit.

It is preferable that the mirror drive circuit stepwise lower the drive frequency of the mirror so that the drive frequency of the mirror becomes the first drive frequency after a predetermined time elapses from the time when the mirror starts to operate.

In this case, until a predetermined time elapses from the time when the mirror starts to operate, the drive frequency of the mirror by the mirror drive circuit becomes stepwise lower. Then, when the predetermined time has passed since the mirror's start, the drive frequency at which the mirror vibrates at a predetermined vibration angle is set for the vibrating mirror by the mirror drive circuit. In this way, the mirror's drive frequency is lowered stepwise one by one. This makes it possible to shift the mirror's vibration angle stably from the second vibration angle to the first vibration angle. Simultaneously, this can be realized in the form of software, if the mirror drive circuit is made up of a CPU, a memory and the like and if a program for setting the mirror's drive frequency at several steps according to the time which has elapsed since the mirror's start is stored in the memory and is executed by the CPU.

Preferably: the vibrating mirror should include, a support member, a mirror member which is supported, as the mirror, via a torsion bar to the support member so that it is vibrated, a mirror electrode which is formed in the mirror member, and a fixed electrode which is formed in the support member; and the mirror drive circuit should vibrate the mirror member by generating electrostatic attraction between the mirror electrode and the fixed electrode.

In this case, the mirror member's driving force by an electrostatic attraction generated between the mirror electrode and the fixed electrode is put out of balance with the mirror member's inertia moment. This makes it possible to start vibrating the mirror member at a vibration angle narrower than a predetermined vibration angle.

An image forming apparatus according to another aspect of the present invention, comprising: a photosensitive drum which forms an electrostatic latent image on its surface; and the above described optical scanner, wherein the light beam reflected by the mirror of the optical scanner is scanned on the photosensitive drum uniformly charged so that an electrostatic latent image is formed in the part scanned by the light beam on the surface of the photosensitive drum.

In this image forming apparatus, the optical scanner's vibrating mirror can be certainly prevented from malfunctioning at its start time. This makes it possible to form an electrostatic latent image stably on the photosensitive drum, thereby forming an image surely.

This application is based on Japanese patent application serial No. 2005-203756, filed in Japan Patent Office on Jul. 13, 2005, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical scanner, comprising:
a light source which emits a light beam;
a vibrating mirror which vibrates a mirror using resonance and allows the mirror to reflect the light beam emitted from the light source so that the light beam is scanned on a scanned surface; and
a mirror drive circuit which applies a drive signal to the vibrating mirror and vibrates the mirror at a first vibration angle when the light beam is scanned on the scanned surface,
wherein the mirror drive circuit vibrates the mirror at a second vibration angle narrower than the first vibration angle when the mirror starts to operate.

2. The optical scanner according to claim 1, wherein the mirror drive circuit: applies a voltage to the vibrating mirror and vibrates the mirror at a vibration angle which corresponds to the amplitude of the applied voltage; when the light beam is scanned on the scanned surface, applies a first voltage to the vibrating mirror and vibrates the mirror at the first vibration angle; and when the mirror starts to operate, applies a second voltage lower than the first voltage to the vibrating mirror and vibrates the mirror at the second vibration angle.

3. The optical scanner according to claim 2, wherein the mirror drive circuit linearly increases the voltage applied to the vibrating mirror so that the voltage applied to the vibrating mirror becomes the first voltage after a predetermined time elapses from the time when the mirror starts to operate.

4. The optical scanner according to claim 2, wherein the mirror drive circuit stepwise increases the voltage applied to the vibrating mirror so that the voltage applied to the vibrating mirror becomes the first voltage after a predetermined time elapses from the time when the mirror starts to operate.

5. The optical scanner according to claim 1, wherein the mirror drive circuit: sets a drive frequency of the mirror for the vibrating mirror and vibrates the mirror at a vibration angle which corresponds to the drive frequency; when the light beam is scanned on the scanned surface, sets the drive frequency of the mirror to a first drive frequency and vibrates the mirror at the first vibration angle; and when the mirror starts to operate, sets a second drive frequency higher than the first drive frequency for the vibrating mirror and vibrates the mirror at the second vibration angle.

6. The optical scanner according to claim 5, wherein the mirror drive circuit linearly lowers the drive frequency of the mirror so that the drive frequency of the mirror becomes the first drive frequency after a predetermined time elapses from the time when the mirror starts to operate.

7. The optical scanner according to claim 5, wherein the mirror drive circuit stepwise lowers the drive frequency of the mirror so that the drive frequency of the mirror becomes the first drive frequency after a predetermined time elapses from the time when the mirror starts to operate.

8. The optical scanner according to claim 1, wherein:
the vibrating mirror includes,
a support member,
a mirror member which is supported, as the mirror, via a torsion bar to the support member so that it is vibrated,
a mirror electrode which is formed in the mirror member, and
a fixed electrode which is formed in the support member; and
the mirror drive circuit vibrates the mirror member by generating electrostatic attraction between the mirror electrode and the fixed electrode.

9. An image forming apparatus, comprising:
a photosensitive drum which forms an electrostatic latent image on its surface; and
the optical scanner according to claim 1,
wherein the light beam reflected by the mirror of the optical scanner is scanned on the photosensitive drum uniformly charged so that an electrostatic latent image is formed in the part scanned by the light beam on the surface of the photosensitive drum.
